(19) United States
(12) Patent Application Publication
(10) Pub. No.: US 2017/0295846 A1
(43) Pub. Date: Oct. 19, 2017

(54) VAPORIZATION ASSEMBLY AND ELECTRONIC CIGARETTE

(71) Applicant: Huizhou Kimree Technology Co., Ltd., Huizhou, Guangdong (CN)

(72) Inventor: Qiuming Liu, Shenzhen, Guangdong (CN)

(21) Appl. No.: 15/512,836

(22) PCT Filed: Sep. 19, 2014
(86) PCT No.: PCT/CN2014/086960

§ 371 Date: Mar. 20, 2017

(51) Int. Cl. A24F 47/00; H05B 3/44; F22B 1/28

(52) U.S. Cl. CPC A24F 47/008; F22B 1/284; H05B 3/44

(57) ABSTRACT

The invention relates to a vaporization assembly and an electronic cigarette; the vaporization assembly comprises an e-liquid cup assembly and a vaporization core arranged in the e-liquid cup assembly; the e-liquid cup assembly has an e-liquid storage chamber used for accommodating e-liquid; the vaporization core comprises a vaporization base and an electric heating wire assembly; the vaporization base is internally provided with a smoke passageway used for providing passage to the smoke produced by vaporization; the electric heating wire assembly is arranged on the smoke passageway; the electric heating wire assembly comprises an electric heating wire used for heating and vaporizing the e-liquid; the vaporization core comprises an insulating tube used for isolating the vaporization base from the electric heating wire; the insulating tube is interposed in the vaporization base, and supports the electric heating wire along the length of the vaporization base.

### FIELD OF THE INVENTION

The present application relates to a technical field of an electronic cigarette, and more particularly relates to a vaporization assembly and an electronic cigarette.

### BACKGROUND OF THE INVENTION

In the prior arts, an electronic cigarette comprises a vaporization assembly and a battery assembly, the vaporization assembly comprises a vaporization sleeve for storing e-liquid and a vaporization core interposed in one end of the vaporization sleeve. The vaporization core is provided with a vaporization base made of a metal material, an internal electrode interposed at one end of the vaporization base, and an electric heating wire assembly for atomizing the e-liquid in the vaporization sleeve. Generally, the electric heating wire assembly is inserted laterally in a middle area of the vaporization base, and the internal electrode and one end of the vaporization base is generally used as electrodes for transferring electrical power to an electric heating wire in the electric heating wire assembly.

However, the electric heating wire wound on the e-liquid guide is liable to be offset when it suffers impact or is inclined for a long time, then the electric heating wire may come to contact with an internal cavity of the vaporization base, resulting in a short circuit in an entire circuit and damage to a control circuit board. This defect of the prior art makes the electronic cigarette easy to be damaged when the electronic cigarette is hit or fallen down, and the user experience is poor.

### SUMMARY OF THE INVENTION

Technical problems to be solved in the present invention is to provide a vaporization assembly and an electronic cigarette which is resistant to impact and is not easy to be damaged in order to solve the defects in the prior art.

Technical solutions of the present application for solving the technical problems are to provide a vaporization assembly configured for forming an electronic cigarette with a battery assembly, wherein the vaporization assembly comprises an e-liquid cup assembly and a vaporization core arranged in the e-liquid cup assembly; the e-liquid cup assembly has an e-liquid storage chamber configured for accommodating e-liquid; the vaporization core comprises a vaporization base and an electric heating wire assembly; the vaporization base is internally provided with a smoke passageway configured for providing a passage to smoke produced by vaporization; the electric heating wire assembly is arranged on the smoke passageway; and the electric heating wire assembly comprises an electric heating wire configured for heating and vaporizing e-liquid; and the vaporization core further comprises an insulating tube configured for isolating the vaporization base from the electric heating wire, so as to prevent the electric heating wire from contacting with an inner wall surface of the vaporization base, the inner wall is defined in the smoke passageway; the insulating tube is inserted in the vaporization base and defined along an axial direction of the vaporization base, two ends of the electric heating wire are both inserted in the insulating tube.

In the vaporization assembly provided in the present invention, the insulating tube is provided with fixing holes for installing the electric heating wire assembly, and two ends of the electric heating wire assembly respectively pass through the fixing holes to arrange on the insulating tube.

In the vaporization assembly provided in the present invention, the vaporization base is further provided with opposite openings for installing the electric heating wire assembly, the electric heating wire assembly further comprises an e-liquid guide, the electric heating wire is wound around a portion of the e-liquid guide, the portion of the e-liquid guide is defined in the insulating tube, two ends of the e-liquid guide respectively pass through the fixing holes and extend outside the openings to obtain the e-liquid from the e-liquid storage chamber for the electric heating wire to heat and vaporize.

In the vaporization assembly provided in the present invention, an outer peripheral surface of the vaporization base is provided with an annular projection for abutting against the two ends of the e-liquid guide.

In the vaporization assembly provided in the present invention, the insulating tube is further provided with a cutout communicating with the fixing holes, the cutout extends from the fixing holes to an outer surface of the insulating tube so that the electric heating wire assembly is clamped in the fixing holes through the cutout when the electric heating wire assembly and the insulating tube are assembled.

In the vaporization assembly provided in the present invention, the cutout extends from the fixing holes to one end surface of the insulating tube, and a direction of the cutout is parallel to an axial direction of the insulating tube.

In the vaporization assembly provided in the present invention, the cutout extends from the fixing holes to a side wall surface of the insulating tube, and a direction of the cutout is perpendicular to or intersects with an axial direction of the insulating tube.

In the vaporization assembly provided in the present invention, the vaporization base is further provided with a second air intake passage for allowing outside air to flow into the smoke passageway, correspondingly, a third air intake passage communicating with the second air intake passage is provided on the insulating tube.

In the vaporization assembly provided in the present invention, an outer wall surface of the insulating tube is fitted with the inner wall surface of the vaporization base, and the insulating tube is abutted against the electric heating wire assembly to support the electric heating wire assembly.

In the vaporization assembly provided in the present invention, the insulating tube is a product of ceramic or glass fiber.

In the vaporization assembly provided in the present invention, the vaporization core further comprises an internal electrode for conducting electrical power for the electric heating wire assembly, the internal electrode is sleeved and fixed at an end of the vaporization base and electrically isolated from the vaporization base.

In the vaporization assembly provided in the present invention, the vaporization base and the internal electrode are made of conductive materials or are coated with conductive materials, and an insulating sleeve is interposed between the internal electrode and the vaporization base.

In the vaporization assembly provided in the present invention, the electric heating wire assembly is electrically connected to the internal electrode through a first conductor, an insulating layer covers on an outer surface of the first conductor, the electric heating wire assembly is electrically connected to the vaporization base through a second conductor, an insulating layer covers on an outer surface of the second conductor; one end of the first conductor is fixed between the insulating sleeve and the internal electrode, one end of the second conductor is fixed between the insulating sleeve and the vaporization base.

In the vaporization assembly provided in the present invention, the vaporization core further comprises a vaporization cap detachably sleeved on one end of the vaporization base, and the end of the vaporization base is opposite to the internal electrode, and the vaporization cap is abutted against the electric heating wire assembly.

In the vaporization assembly provided in the present invention, the e-liquid cup assembly comprises a vaporization sleeve connected to the vaporization base, a vent pipe communicating with the smoke passageway, and an e-liquid separator arranged at an end of the vaporization sleeve; the vaporization core, the vaporization sleeve, the vent pipe and the e-liquid separator surround to form the e-liquid storage chamber for storing the e-liquid.

In the vaporization assembly provided in the present invention, the e-liquid cup assembly further comprises a first sealing ring defined between the vaporization sleeve and the e-liquid separator, the vaporization sleeve is interference fitted with the e-liquid separator, and a first sealing groove for receiving the first sealing ring is provided on an outer side surface of the e-liquid separator along a circumferential direction of the e-liquid separator.

In the vaporization assembly provided in the present invention, the e-liquid cup assembly further comprises a first sealing ring defined between the vaporization sleeve and the e-liquid separator, the vaporization sleeve is interference fitted with the e-liquid separator, and a first sealing groove for receiving the first sealing ring is provided on an outer side surface of the e-liquid separator along a circumferential direction of the vaporization base.

In the vaporization assembly provided in the present invention, the e-liquid cup assembly further comprises a second sealing ring defined between the vaporization sleeve and the vaporization base, a second sealing groove for receiving the second sealing ring is provided on an outer side surface of the vaporization base along a circumferential direction of the vaporization base.

In the vaporization assembly provided in the present invention, the vaporization assembly further comprises a suction nozzle assembly detachably connected to the vaporization sleeve, the suction nozzle assembly provides a smoking passage communicating with the vent pipe, the smoking passage extends through the suction nozzle assembly along an axial direction of the suction nozzle assembly.

The present invention further comprises an electronic cigarette, the electronic cigarette comprises the above vaporization assembly and the battery assembly configured for supplying electrical power to the vaporization assembly.

Applications of the vaporization assembly and an electronic cigarette of the present invention have following advantages: when the electronic cigarette is subjected to an impact or inclination for a long time, an additional arrange of an insulating tube to isolate the electric heating wire and the vaporization base for conducting electrical power for the electric heating wire to prevent the electric wire from being offset and in contact with the internal cavity of the vaporization base, then a resistance value connected into a circuit is changed can be avoided, thereby to avoid heating temperature instability of the electric heating wire assembly.

Moreover, the offset of the electric heating wire and the contact between the electric heating wire and the internal cavity of the vaporization base may cause an entire circuit to be short-circuited and then the control circuit board is directly damaged. By isolating with a method of the insulating tube, it is possible to avoid a problem of health of a user due to the fact that it is easy to suck peeling paint when the user is smoking, and it is easy to assemble and has a high production efficiency.

Further, the insulating tube is made of glass fibers so as to adsorb the e-liquid leaked or condensed on the smoke passage, and the user can be well prevented from inhaling the e-liquid, and the glass fibers has a characteristic of a high temperature resistance, thus, it is better to prevent the electric heating wire from burning the insulating tube, and it is possible to ensure the health of the user well; both the insulating tube and the annular projections on the vaporization base support the electric heating wire assembly axially to further protect the electric heating wire assembly to increase a stability of an electrical connection of the electric heating wire assembly;

Thus, the vaporization assembly of the present invention has a strong impact resistance, avoids a short circuit, has a long service life and an excellent user experience.

### BRIEF DESCRIPTION OF THE DRAWINGS

The present invention will be further described with reference to the accompanying drawings and embodiments in the following.

FIG. 1 is a schematic structural view of a vaporization assembly provided in a first preferred embodiment of the present invention;

FIG. 2 is a schematic structural diagram of a vaporization core in FIG. 1;

FIG. 3 is a dimensional split diagram of the vaporization core in FIG. 1;

FIG. 4 is a dimensional structural diagram of the vaporization core in FIG. 1;

FIG. 5 is a schematic structural view of a vaporization core provided in a second preferred embodiment of the present invention;

FIG. 6 is a schematic structural view of a vaporization core provided in a third preferred embodiment of the present invention;

FIG. 7 is a schematic structural view of a vaporization assembly provided in a fourth preferred embodiment of the present invention;

FIG. 8 is a dimensional structural diagram of the vaporization core in FIG. 7.

### DETAILED DESCRIPTION OF THE PREFERRED EMBODIMENT

To make the technical feature, objective and effect of the present application be understood more clearly, now the specific implementation of the present application is described in detail with reference to the accompanying drawings and embodiments.

The present invention provides a vaporization assembly configured for forming an electronic cigarette with a battery assembly (not labeled in drawings). The battery assembly comprises a battery for supplying electrical power to the vaporization assembly, a control circuit board for controlling an operating state of the vaporization assembly, battery electrodes for being electrically connected to the vaporization assembly, and a battery sleeve for accommodating the battery, the control circuit board and the battery electrodes, since the related structures and arrangements of the battery assembly in this application are within the scope of the prior art, and will not be described again.

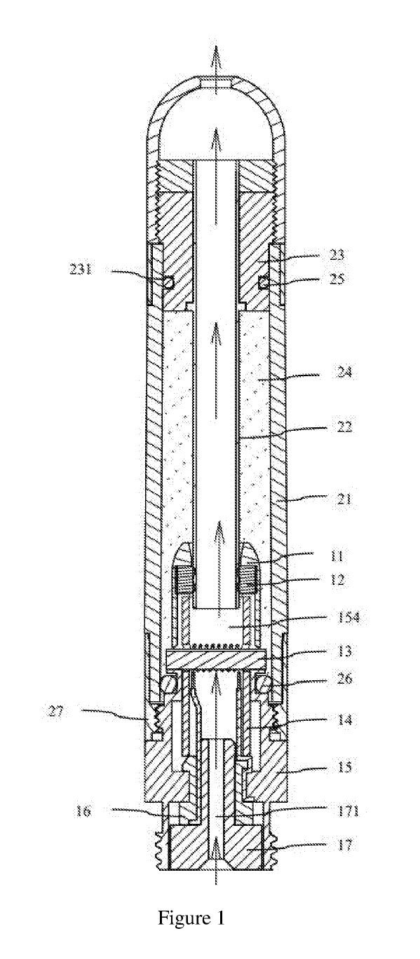

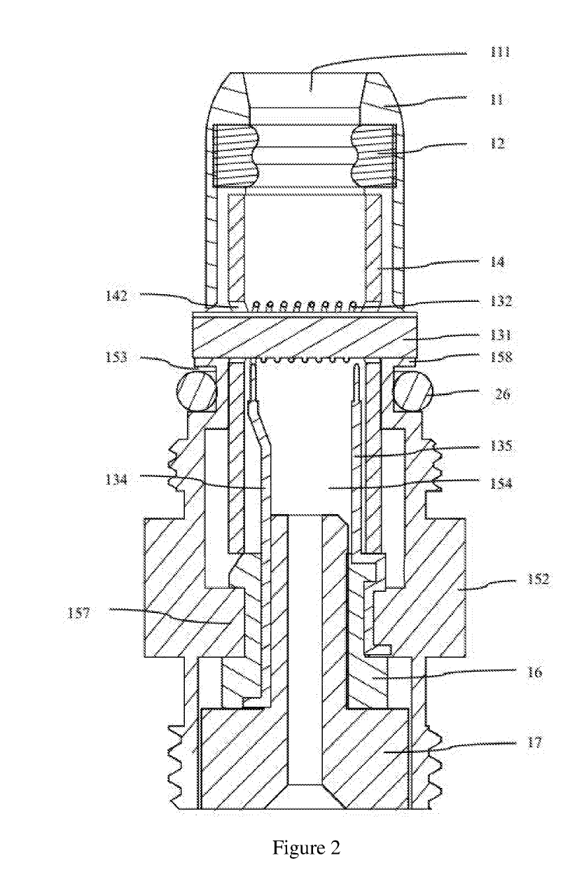

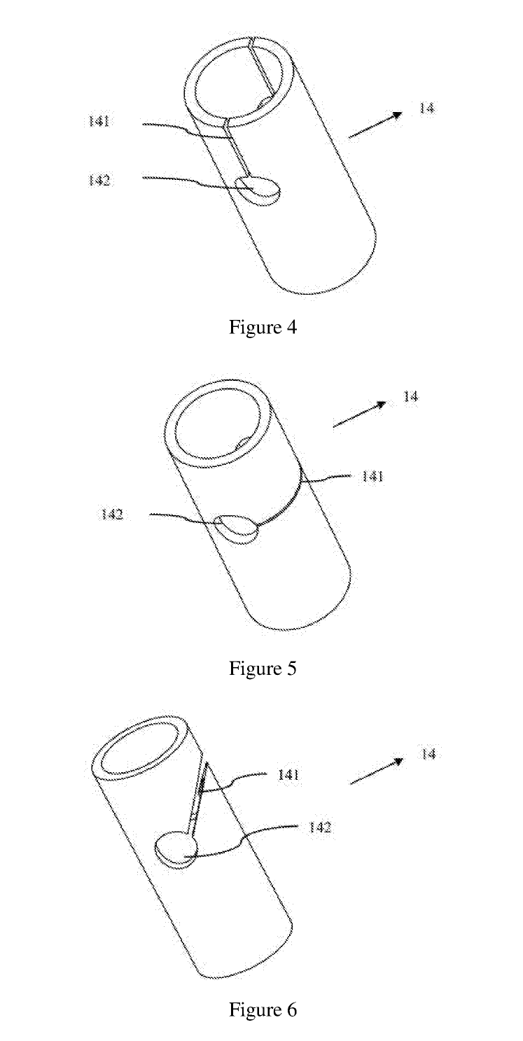

### Embodiment 1: Referring to FIGS. 1, 2, 3 and 4

The vaporization assembly provided by the present invention comprises an e-liquid cup assembly and a vaporization core arranged in the e-liquid cup assembly, the e-liquid cup assembly comprises a vaporization sleeve 21, a vent pipe 22, an e-liquid separator 23 and a suction nozzle assembly, and the vaporization core, the vaporization sleeve 21, the vent pipe 22 and the e-liquid separator 23 surround to form an e-liquid storage chamber 24 for storing the e-liquid.

The vaporization sleeve 21 is a hollow tubular structure, one end of the vaporization sleeve 21 is detachably connected to the vaporization core through the connecting member 27, and the other end of the vaporization sleeve 21 is detachably connected to the e-liquid separator 23 and the suction nozzle assembly, respectively. In the present embodiment, the e-liquid separator 23 is inserted into an end of the vaporization sleeve 21 to avoid a leaking of the e-liquid, and the suction nozzle assembly is fitted outside the vaporization sleeve 21 and detachably connected to the vaporization sleeve 21. Certainly, the vaporization sleeve 21, the vent pipe 22, and the suction nozzle assembly can be integrally molded, and are not specifically limited thereto

The vent pipe 22 is inserted axially into the vaporization sleeve 21, one end of the vent pipe 22 is connected to the vaporization core and the other end of the vent pipe 22 is connected to the e-liquid separator 23; the e-liquid separator 23 and the suction nozzle assembly provide a smoking passage communicating the e-liquid separator 23 and the suction nozzle assembly mutually, the vent pipe 22 communicates with the smoking passage, so that smoke obtained by an atomization of the vaporization core can pass through the vent pipe 22 and the smoking passage sequentially to flow into the user's mouth.

Preferably, the e-liquid cup assembly further comprises a first sealing ring 25 defined between the vaporization sleeve 21 and the e-liquid separator 23, the first sealing ring 25 is configured for preventing the e-liquid in the e-liquid storage chamber 24 from leaking out through a gap between the vaporization sleeve 21 and the e-liquid separator 23, correspondingly, a first sealing groove 231 for receiving the first sealing ring 25 is provided on an outer side surface of the e-liquid separator 23 along a circumferential direction of the e-liquid separator 23.

Preferably, the vaporization sleeve 21 is interference fitted with the e-liquid separator 23, then it is possible to minimize a leakage of the e-liquid and meanwhile to prevent the e-liquid separator 23 from being released.

Preferably, the e-liquid cup assembly further comprises a second sealing ring 26 defined between the vaporization sleeve 21 and the vaporization core, the second sealing ring 26 is configured for preventing the e-liquid in the e-liquid storage chamber 24 from leaking out through a gap between the vaporization sleeve 21 and the vaporization core.

The vaporization core provided by the present invention specifically comprises a vaporization base 15 for connecting with the vaporization sleeve 21 or the like component to form a vaporization assembly, an electric heating wire assembly 13 for heating and atomizing the e-liquid, and an insulating tube 14 configured for isolating the vaporization base 15 from an electric heating wire 132 in the electric heating wire assemble 13, the vaporization base 15 is internally provided with a smoke passageway 154 configured for providing passage to smoke produced by vaporization; the electric heating wire assembly 13 is arranged on the smoke passageway 154.

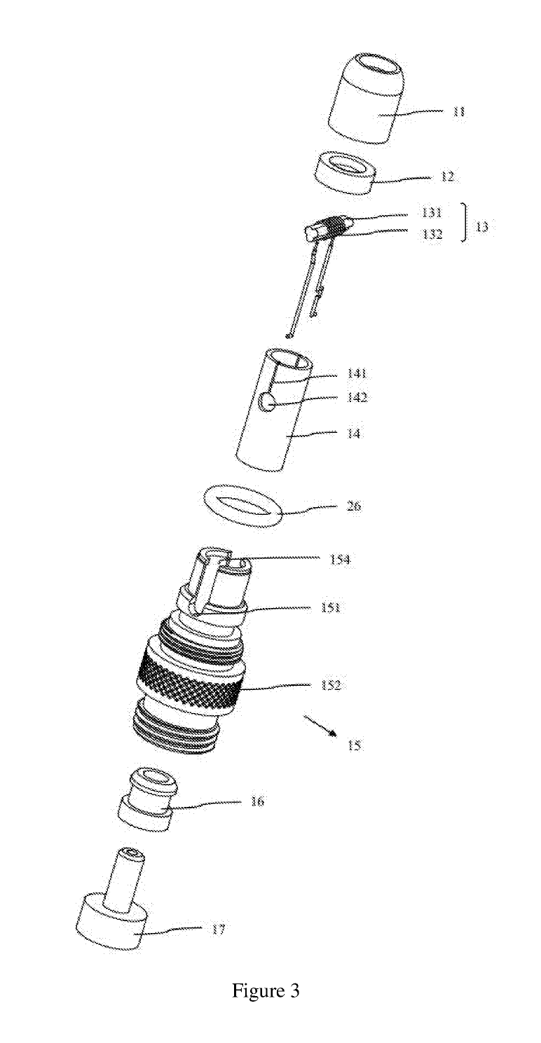

According to FIG. 3, the vaporization base 15 has a generally tubular structure having a large outer diameter in the middle and a small outer diameter at both ends, a second sealing groove 153 for receiving the second sealing ring 26 is provided on an outer side surface of the vaporization base 15 along a circumferential direction of the vaporization base 15.

The largest part of the outer diameter of the vaporization base 15 is a hand holding part 152, one side of the hand holding part 152 is provided with an internal electrode 17 and a screw thread structure which is detachably connected to an external battery assembly; the other side of the hand holding part 152 is also provided with a screw thread structure which can be detachably connected to the connecting member 27, this screw thread structure is configured for cooperating with the connecting member 27 to detachably clamp and fix the vaporization sleeve 21.

It is preferable that a knurling structure is provided on an outer peripheral surface of the hand holding portion 152 for increasing friction so that the user can disassemble and assemble the vaporization sleeve 21 and/or the battery assembly, and also preventing the electronic cigarette from slipping, convenient the user to hold the electronic cigarette.

The vaporization base 15 is a stepped tubular structure, thus the vaporization base 15 has a smoke passageway 154 penetrating the vaporization base 15 along an axial direction of the vaporization base 15 for a passage of smoke after the vaporization. A side wall of the vaporization base 15 is further provided with a pair of openings 151 for installing the electric heating wire assembly 13, the openings 151 are defined opposite to each other, the electric heating wire assembly 13 is arranged on the smoke passageway 154 and two ends of the electric heating wire assembly 13 respectively extend outside the opening 151. When replacing the electric heating wire assembly 13, it is only necessary to directly displace and then place the electric heating wire assembly 13 along the opening 151.

The internal electrode 17 is provided with a first intake passage 171 in its axial direction for allowing an entrance of outside airflow, and the first intake passage 171 communicates with the smoke passageway 154. When the user smokes, the outside airflow enters the smoke passageway 154 through the first intake passage 171 and flows through the electric heating wire assembly 13 provided on the smoke passageway 154 to generate smoke, the generated smoke continues to flow along the smoke passageway 154, enter the vent pipe 22 communicating with the smoke passageway 154 and then flows into the user's mouth through the smoking passage provided in the suction nozzle assembly.

The internal electrode 17 is inserted into one end of the vaporization base 15, the end is close to the battery assembly, and the internal electrode 17 and the vaporization base 15 are electrically connected to the external battery assembly, respectively, to conduct the electrical power to the electric heating wire assembly 13 as electrodes. Preferably, the vaporization base 15 and the internal electrode 17 are made of conductive materials or are coated with conductive materials, the internal electrode 17 is electrically connected to a first electrode (not shown in the drawings) in the battery assembly, and the vaporization base 15 is electrically connected to a second electrode (not shown in the drawings) in the battery assembly.

In order to ensure an electrical isolation between the internal electrode 17 and the vaporization base 15, the vaporization core in the present invention further comprises an insulating sleeve 16 interposed between the internal electrode 17 and the vaporization base 15. It is to be understood that a method of electrically isolating is not limited to the use of the insulating sleeve 16, and an insulating medium or the like may be coated on an interface where the internal electrode 17 is in contact with the vaporization base 15, and it is not limited thereto.

The electric heating wire assembly 13 comprises an e-liquid guide 131 and the electric heating wire 132.

The insulating tube 14 is inserted in the vaporization base 15, the insulating tube 14 is configured for isolating the vaporization base 15 from the electric heating wire 132 so as to prevent the electric heating wire 132 from contacting with an inner wall surface of the vaporization base 15, the inner wall is defined in the smoke passageway 154, two ends of the electric heating wire 132 are both inserted in the same insulating tube 14. The insulating tube 14 is correspondingly provided with fixing holes 142 for allowing the e-liquid guide 131 to extend. The e-liquid guide 131 is made of an e-liquid absorbing material and has two ends passing through the fixing holes 142 respectively and then passing through the openings 151 respectively to extend into the e-liquid storage chamber 24 to suck the e-liquid for the electric heating wire 132 to heat and atomize; the electric heating wire 132 is wound around a portion of the e-liquid guide 131, the portion of the e-liquid guide 131 is defined in the insulating tube 14, two ends of the electric heating wire 132 are electrically connected to the vaporization base 15 and the internal electrode 17 through conductors, respectively.

The electric heating wire assembly 13 is electrically connected to the internal electrode 17 through a first conductor 134, an insulating layer covers on an outer surface of the first conductor 134, the electric heating wire assembly 13 is electrically connected to the vaporization base 15 through a second conductor 135, an insulating layer covers on an outer surface of the second conductor 135. In the present invention, one end of the first conductor 134 is clamped and fixed in a gap between the insulating sleeve 16 and the internal electrode 17, one end of the second conductor 135 is clamped and fixed in a gap between the insulating sleeve 16 and the vaporization base 15. The other ends of the first conductor 134 and the second conductor 135 are electrically connected to two ends of the electric heating wire 132 in the electric heating wire assembly 13, respectively. Since the first conductor 134 and the second conductor 135 are not generated heat when they are conducted or the amount of generated heat is small, then waste of energy can be reduced, and it is convenient for the battery assembly to drive the electric heating wire 132. Certainly, in other embodiments, it is not necessary to provide the first conductor 134 and the second conductor 135, and this is not particularly limited.

It is preferable that the inner wall of the vaporization base 15 protrudes inwardly to form an installing convex platform 157, one end of the insulating tube 14 is abutted against the e-liquid guide 131, and the other end of the insulating tube 14 is abutted against the installing convex platform 157.

Preferably, the insulating tube 14 is defined coaxially with the inner cavity of the vaporization base and the insulating tube 14 is abutted against the electric heating wire assembly 13 to support the electric heating wire assembly 13, the insulating tube 14 may be made of glass fiber, silica gel or ceramic or the like class of insulated and heat-resistant material. In the present embodiment, the insulating tube 14 is made of glass fibers, so as to adsorb the e-liquid leaked or condensed on the smoke passage, and the user can be well prevented from inhaling the e-liquid, and the glass fibers has a characteristic of a high temperature resistance, thus, it is better to prevent the electric heating wire from burning the insulating tube, and to ensure the health of the user well. Since the insulating tube 14 is abutted against the electric heating wire assembly 13 to support the electric heating wire assembly 13, when the vaporization assembly is shaken, the electric heating wire 132 is prevented from shaking to avoid a direct contact between adjacent circles of the electric heating wire 132 resulting a phenomenon of unstable smoke caused by an unstable electrical resistance. More preferably, the insulating tube 14 is formed by a plurality of staggered ropes made of glass fiber so as to have a well elasticity.

Preferably, an outer peripheral surface of the vaporization base 15 is provided with an annular projection 158 for abutting against the two ends of the e-liquid guide 131. The annular projection 158 is configured for supporting the electric heating wire assembly 13 in the axial direction of the vaporization core, and preventing the electric heating wire assembly 13 from shaking or damaging to affect heating stability.

The insulating tube 14 is provided with cutouts 141 communicating with the fixing holes 142 correspondingly, the cutouts 141 extend from the fixing holes 142 to an outer surface of the insulating tube 14 so that it is convenient to assemble the electric heating wire 132 and the e-liquid guide 131.

In the present embodiment, the cutouts 141 extends from the fixing holes 142 to one end surface of the insulating tube 14, and a direction of the cutouts 141 is parallel to an axial direction of the insulating tube 14, namely, the cutouts 141 are vertically arranged.

Besides, the vaporization core further comprises a vaporization cap 11 and a sealing sleeve 12.

The vaporization cap 11 is sleeved at one end of the vaporization base 15, the end is opposite to the internal electrode 17, the vaporization cap 11 is provided with a communication hole 111 communicating with the smoke passageway 154, the vent pipe 22 is inserted into the communication hole 111 and is directly communicated with the smoke passageway 154.

The sealing sleeve 12 is clamped between the vaporization cap 11 and the vent pipe 22 for preventing the e-liquid in the e-liquid storage chamber 24 from flowing into the smoke passageway 154 along a gap between the vaporization cap 11 and the vent pipe 22.

### Embodiment 2: Referring to FIG. 5 with a Combination with FIGS. 1, 2 and 3

The present embodiment is different from Embodiment 1 in that the insulating tube 14 is defined coaxially with the internal cavity of the vaporization base 15, the cutout 141 extends from the fixing holes 142 to a side wall surface of the insulating tube 14, and a direction of the cutout 141 is perpendicular to an axial direction of the insulating tube 14, namely, the cutout 141 is defined horizontally.

### Embodiment 3: Referring to FIG. 6 with a Combination with FIGS. 1, 2 and 3

The present embodiment is different from the above embodiments in that the insulating tube 14 is defined coaxially with the internal cavity of the vaporization base 15, the cutout 141 extends from the fixing holes 142 to a side wall surface of the insulating tube 14, and a direction of the cutout 141 intersects with an axial direction of the insulating tube 14, namely, the cutout 141 is defined obliquely.

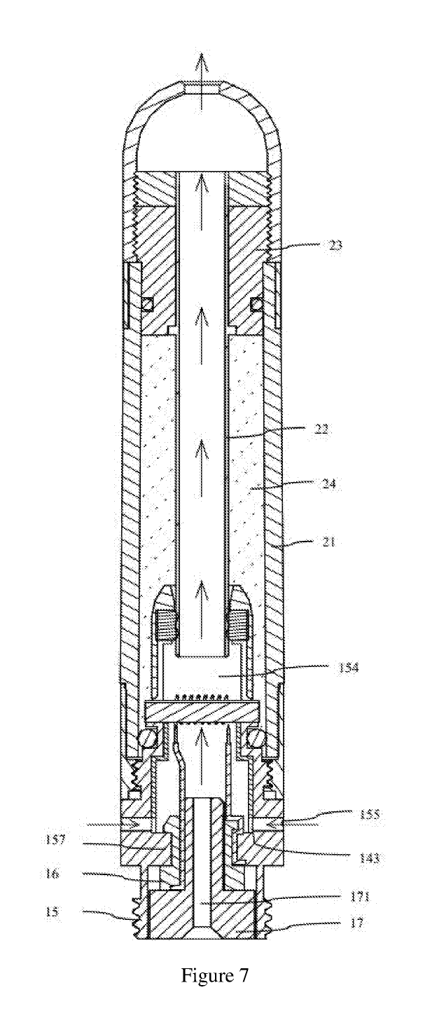

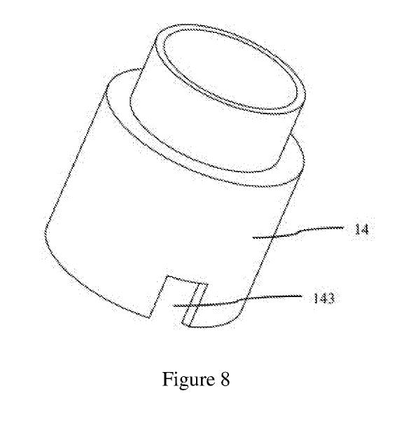

### Embodiment 4: Referring to FIG. 7 and FIG. 8

The present embodiment is different from the above embodiments in that the vaporization base 15 is further provided with a second air intake passage 155 for outside air to enter the smoke passageway 154, correspondingly, a third air intake passage 143 communicating with the second air intake passage 155 is provided on the insulating tube 14.

In addition, the insulating tube 14 in the present embodiment does not provide the fixing holes 142 and the cutout 141 for the e-liquid guide 131 to pass through, but the insulating tube 14 is provided between the e-liquid guide 131 and the installing convex platform 157.

In the present embodiment, one end of the insulating tube 14 is abutted against the e-liquid guide 131 and the other end of the insulating tube 14 is abutted against the installing convex platform 157 to simplify an assembling process of the electric heating wire assembly 13, namely, steps of installing the e-liquid guide 131 and the electric heating wire 132 into the insulating tube 14 is omitted.

A length of the electric heating wire 132 wound on the e-liquid guide 131 is smaller than an inner diameter of the insulating tube 14, and a projection of the electric heating wire 132 along its axial direction falls within the end surface of the insulating tube 14 to ensure that the insulating tube 14 can effectively isolate the electric heating wire 132 from the vaporization base 15, and to avoid a direct contact to lead an conduction between the electric heating wire 132 and the vaporization base 15.

It is preferable that the insulating tube 14 in the present embodiment is provided in close contact with the inner wall surface of the vaporization base 15 and a shape and size of the insulating tube 14 are matched with those of the inner wall of the vaporization base 15 to prevent the insulating tube 14 from shaking in the vaporization base 15 resulting in that a reliably isolation between the electric heating wire 132 and the vaporization base 15 cannot be achieved.

Preferably, the insulating tube 14 may be made of glass or ceramic.

When the user smokes, the outside airflow enters the smoke passageway 154 from the first air intake passage 171 while the outside airflow enters the smoke passageway 154 from the second air intake passage 155 and the third intake passage 143 as well, thereby increasing an amount of air inflow and improving an user experience.

Each embodiment of the present specification is described in a progressive manner, each embodiment is focused on differences from other embodiments, and the same or similar parts between the various embodiments may be referred to each other.

It is to be understood that an opening path of the associated air intake passage is not limited to the present invention as long as a connection between the outside and the smoke passageway 154 can be realized, and only a few preferred embodiments are given herein, and it is not particularly limited.

It is to be understood that methods for the detachable connection between the vaporization core and the vaporization sleeve 21, and the detachable connection between the connecting member 27 and the battery assembly are not limited to the present invention, they may be a variety of common detachable connection methods, such as a threaded connection, a snap connection, an interference fit, and so on, the methods are not specifically defined here.

Applications of the vaporization assembly and an electronic cigarette of the present invention have following advantages: when the electronic cigarette is subjected to an impact or inclination for a long time, an additional arrange of an insulating tube 14 to isolate the electric heating wire 132 and the vaporization base 15 for conducting electrical power for the electric heating wire 132 to prevent the electric heating wire 132 from being offset and in contact with the internal cavity of the vaporization base 15, then a resistance value of the electric heating wire 132 connected into a circuit is changed can be avoided, thereby to avoid heating temperature instability of the electric heating wire assembly 13. Moreover, the offset of the electric heating wire 132 and the contact between the electric heating wire 132 and the internal cavity of the vaporization base 15 may cause an entire circuit to be short-circuited and then the control circuit board is directly damaged. Thus, with the application of the insulating tube 14, the vaporization core has a effectively reinforced impact resistance, avoid a short circuit, a service life of the the vaporization core is prolonged and the user experience is improved.

While the embodiments of the present application are described with reference to the accompanying drawings above, the present application is not limited to the above-mentioned specific implementations. In fact, the above-mentioned specific implementations are intended to be exemplary not to be limiting. In the inspiration of the present application, those ordinary skills in the art can also make many modifications without breaking away from the subject of the present application and the protection scope of the claims. All these modifications belong to the protection of the present application.

1. A vaporization assembly configured for forming an electronic cigarette with a battery assembly, wherein the vaporization assembly comprises an e-liquid cup assembly and a vaporization core arranged in the e-liquid cup assembly; the e-liquid cup assembly has an e-liquid storage chamber (24) configured for accommodating e-liquid;
wherein the vaporization core comprises a vaporization base (15) and an electric heating wire assembly (13); the vaporization base (15) is internally provided with a smoke passageway (154) configured for providing a passage to smoke produced by vaporization; the electric heating wire assembly (13) is arranged on the smoke passageway (154); and the electric heating wire assembly (13) comprises an electric heating wire (132) configured for heating and vaporizing the e-liquid; and
wherein the vaporization core further comprises an insulating tube (14) configured for isolating the vaporization base (15) from the electric heating wire (132), so as to prevent the electric heating wire (132) from contacting with an inner wall surface of the vaporization base (15), the inner wall is defined in the smoke passageway (154); the insulating tube (14) is inserted in the vaporization base (15) and defined along an axial direction of the vaporization base (15), two ends of the electric heating wire (132) are both inserted in the insulating tube (14).

2. The vaporization assembly according to claim 1, wherein the insulating tube (14) is provided with fixing holes (142) for installing the electric heating wire assembly (13), and two ends of the electric heating wire assembly (13) respectively pass through the fixing holes (142) to arrange on the insulating tube (14).

3. The vaporization assembly according to claim 2, wherein the vaporization base (15) is further provided with opposite openings (151) for installing the electric heating wire assembly (13), the electric heating wire assembly (13) further comprises an e-liquid guide (131), the electric heating wire (132) is wound around a portion of the e-liquid guide (131), the portion of the e-liquid guide (131) is defined in the insulating tube (14), two ends of the e-liquid guide (131) respectively pass through the fixing holes (142) and extend outside the openings (151) to obtain the e-liquid from the e-liquid storage chamber (24) for the electric heating wire (132) to heat and vaporize.

4. The vaporization assembly according to claim 3, wherein an outer peripheral surface of the vaporization base (15) is provided with an annular projection (158) for abutting against the two ends of the e-liquid guide (131).

5. The vaporization assembly according to claim 2, wherein the insulating tube (14) is further provided with a cutout (141) communicating with the fixing holes (142), the cutout (141) extends from the fixing holes (142) to an outer surface of the insulating tube (14) so that the electric heating wire assembly (13) is clamped in the fixing holes (142) through the cutout (141) when the electric heating wire assembly (13) and the insulating tube (14) are assembled.

6. The vaporization assembly according to claim 5, wherein the cutout (141) extends from the fixing holes (142) to one end surface of the insulating tube (14), and a direction of the cutout (141) is parallel to an axial direction of the insulating tube (14).

7. The vaporization assembly according to claim 5, wherein the cutout (141) extends from the fixing holes (142) to a side wall surface of the insulating tube (14), and a direction of the cutout (141) is perpendicular to or intersects with an axial direction of the insulating tube (14).

8. The vaporization assembly according to claim 1, wherein the vaporization base (15) is further provided with a second air intake passage (155) for allowing outside air to flow into the smoke passageway (154), correspondingly, a third air intake passage (143) communicating with the second air intake passage (155) is provided on the insulating tube (14).

9. The vaporization assembly according to claim 1, wherein an outer wall surface of the insulating tube (14) is fitted with the inner wall surface of the vaporization base (15), and the insulating tube (14) is abutted against the electric heating wire assembly (13) to support the electric heating wire assembly (13).

10. The vaporization assembly according to claim 1, wherein the insulating tube (14) is made of ceramic or glass fiber.

11. The vaporization assembly according to claim 1, wherein the vaporization core further comprises an internal electrode (17) for conducting electrical power for the electric heating wire assembly (13), the internal electrode (17) is sleeved and fixed at an end of the vaporization base (15) and electrically isolated from the vaporization base (15).

12. The vaporization assembly according to claim 11, wherein the vaporization base (15) and the internal electrode (17) are made of conductive materials or are coated with conductive materials, and an insulating sleeve (16) is interposed between the internal electrode (17) and the vaporization base (15).

13. The vaporization assembly according to claim 12, wherein the electric heating wire assembly (13) is electrically connected to the internal electrode (17) through a first conductor (134), an insulating layer covers on an outer surface of the first conductor (134), the electric heating wire assembly (13) is electrically connected to the vaporization base (15) through a second conductor (135), an insulating layer covers on an outer surface of the second conductor (135);
one end of the first conductor (134) is fixed between the insulating sleeve (16) and the internal electrode (17), one end of the second conductor (135) is fixed between the insulating sleeve (16) and the vaporization base (15).

14. The vaporization assembly according to claim 11, wherein the vaporization core further comprises a vaporization cap (11) detachably sleeved on one end of the vaporization base (15), and the end of the vaporization base (15) is opposite to the internal electrode (17), and the vaporization cap (11) is abutted against the electric heating wire assembly (13).

15. The vaporization assembly according to claim 1, wherein the e-liquid cup assembly comprises a vaporization sleeve (21) connected to the vaporization base (15), a vent pipe (22) communicating with the smoke passageway (154), and an e-liquid separator (23) arranged at an end of the vaporization sleeve (21); the vaporization core, the vaporization sleeve (21), the vent pipe (22) and the e-liquid separator (23) surround to form the e-liquid storage chamber (24) for storing the e-liquid.

16. The vaporization assembly according to claim 15, wherein the e-liquid cup assembly further comprises a first sealing ring (25) defined between the vaporization sleeve (21) and the e-liquid separator (23), the vaporization sleeve (21) is interference fitted with the e-liquid separator (23), and a first sealing groove (231) for receiving the first sealing ring (25) is provided on an outer side surface of the e-liquid separator (23) along a circumferential direction of the e-liquid separator (23).

17. The vaporization assembly according to claim 15, wherein one end of the vaporization core is further provided with a vaporization cap (11) and a sealing sleeve (12), the end of the vaporization core is opposite to the internal electrode (17), the vaporization cap (11) is provided with a communication hole (111) communicating with the smoke passageway (154), the vent pipe (22) is inserted into the communication hole (111), the sealing sleeve (12) is clamped between the vaporization cap (11) and the vent pipe (22).

18. The vaporization assembly according to claim 15, wherein the e-liquid cup assembly further comprises a second sealing ring (26) defined between the vaporization sleeve (21) and the vaporization base (15), a second sealing groove (153) for receiving the second sealing ring (26) is provided on an outer side surface of the vaporization base (15) along a circumferential direction of the vaporization base (15).

19. The vaporization assembly according to claim 15, wherein the vaporization assembly further comprises a suction nozzle assembly detachably connected to the vaporization sleeve (21), the suction nozzle assembly is provided with a smoking passage communicating with the vent pipe (22), the smoking passage extends through the suction nozzle assembly along an axial direction of the suction nozzle assembly.

20. An electronic cigarette, wherein the electronic cigarette comprises the vaporization assembly in claim 1 and a battery assembly configured for supplying electrical power to the vaporization assembly.
